(19) United States
(12) Patent Application Publication
(10) Pub. No.: US 2016/0231771 A1
(43) Pub. Date: Aug. 11, 2016

(54) DISPLAY EQUIPMENT AND DISPLAY METHOD

(71) Applicant: Acer Incorporated, New Taipei City (TW)

(72) Inventors: Wen-Chung CHIU, New Taipei City (TW); Wen-Shu LEE, New Taipei City (TW)

(21) Appl. No.: 14/884,960

(22) Filed: Oct. 16, 2015

(30) Foreign Application Priority Data
Feb. 11, 2015 (TW) 104104510

(51) Int. Cl. G06F 1/16; H04B 1/3888; G02B 27/14

(52) U.S. Cl. CPC G06F 1/1603; G02B 27/144; H04B 1/3888

(57) ABSTRACT

A display equipment connected to an electronic device is provided, including a flat optical component and a pivot unit, wherein the optical component includes a semitransparent reflective element. The pivot unit is pivotally connected to the optical component and the electronic device. When the optical component is in a first position and substantially parallel to a display surface of the electronic device, the light emitted from the display surface passes through the optical component. When the optical component rotates from the first position to the second position relative to the electronic device with an inclined angle formed between the optical component and the display surface, the light emitted from the display surface is reflected by the semitransparent reflective element to a user.

### CROSS REFERENCE TO RELATED APPLICATIONS

The present application is based on, and claims priority from, Taiwan Patent Application No. 104104510, filed on Feb. 11, 2015, the disclosure of which is hereby incorporated by reference herein in its entirety.

### BACKGROUND OF THE INVENTION

1. Field of the Invention

The application relates in general to a display equipment, and in particular, to a display equipment with a semitransparent reflective member.

2. Description of the Related Art

Most of the portable electronic devices in use nowadays (for example, smartphones and tablet computers) have navigation features. For the most part, the user cannot take the portable electronic device in hand when he is driving, and so a holding device is required to hold the portable electronic device upright. However, when the portable electronic device is upright, the sight on the back of the portable electronic device is shielded, and driving safety may be affected. For this reason, how to provide a navigation screen to the user without affecting the sight thereof has become an important issue.

### BRIEF SUMMARY OF INVENTION

To address the deficiencies of conventional electronic products, an embodiment of the invention provides a display equipment connected to an electronic device, comprising a flat optical component and a pivot unit, wherein the optical component comprises a semitransparent reflective element. The pivot unit is pivotally connected to the optical component and the electronic device. When the optical component is in a first position and substantially parallel to a display surface of the electronic device, the light emitted from the display surface passes through the optical component. When the optical component rotates from the first position to the second position relative to the electronic device with an inclined angle formed between the optical component and the display surface, the light emitted from the display surface is reflected by the semitransparent reflective element to the user.

In some embodiments, the optical component further comprises a transparent protecting member connected to the semitransparent reflective member, wherein when the optical component is in the first position, the semitransparent reflective member is disposed between the transparent protecting member and the electronic device.

In some embodiments, the optical component further comprises a transparent insulating member connected to the semitransparent reflective member, wherein when the optical component is in the first position, the transparent protecting member is disposed between the semitransparent reflective member and the electronic device.

In some embodiments, the display equipment further comprises an accommodating member for accommodating the electronic device, and the pivot unit is pivotally connected to the accommodating member and the optical component.

In some embodiments, the accommodating member comprises an electrical connector for electrically connecting the electronic device.

In some embodiments, the thickness of the optical component is 0.1 mm-0.2 mm.

In some embodiments, the dimensions of the optical component exceed or are equal to those of the display surface.

A display method is also provided in the invention, comprising providing an optical component, wherein the optical component is rotatable around a rotation axis relative to an electronic device and comprises a semitransparent reflective member; rotating the optical component and forming an inclined angle between the optical component and a display surface of the electronic device; and mirroring an image on the display surface relative to a central axis of the display surface when the inclined angle is formed between the optical component and the display surface, wherein the mirrored image is reflected to a user by the semitransparent reflective member, and the central axis is parallel to the rotation axis.

In some embodiments, the inclined angle is 30°-80°.

In some embodiments, the electronic device is a smartphone or a tablet computer.

### BRIEF DESCRIPTION OF DRAWINGS

The invention can be more fully understood by reading the subsequent detailed description and examples with references made to the accompanying drawings, wherein:

FIG. 1 is a schematic diagram of a display equipment according to an embodiment of the invention;

FIG. 2 is an exploded-view diagram of the display equipment in FIG. 1;

FIG. 3 is an enlarged partial schematic diagram of the display equipment in FIG. 1;

FIG. 4 is an enlarged cross-sectional view of an optical component according to an embodiment of the invention;

FIGS. 5A-5C is a schematic diagram of the display equipment when the optical component is in a first position; and

FIGS. 6A-6B is a schematic diagram of the display equipment when the optical component is in a second position.

### DETAILED DESCRIPTION OF INVENTION

The making and using of the embodiments of the display equipment and the display method are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

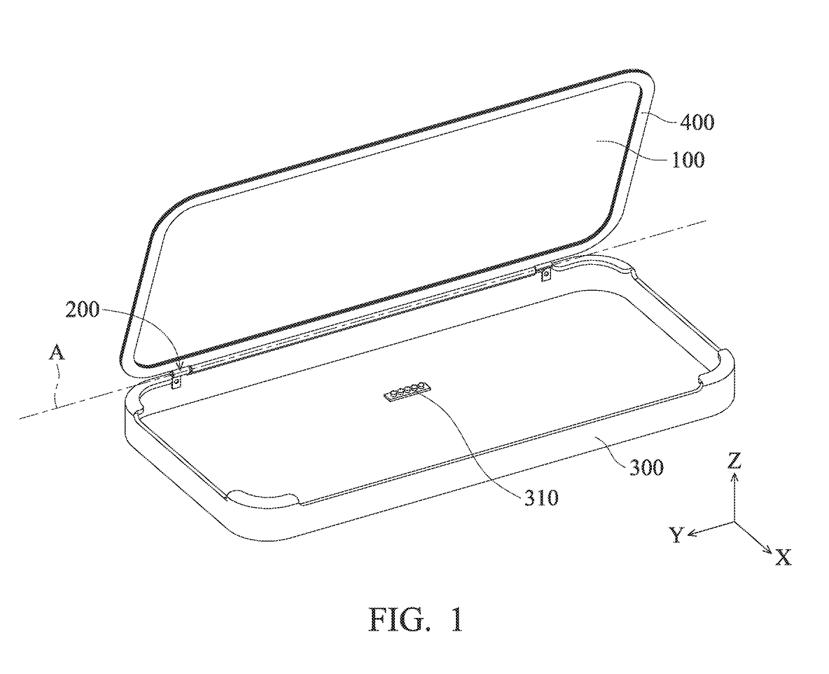

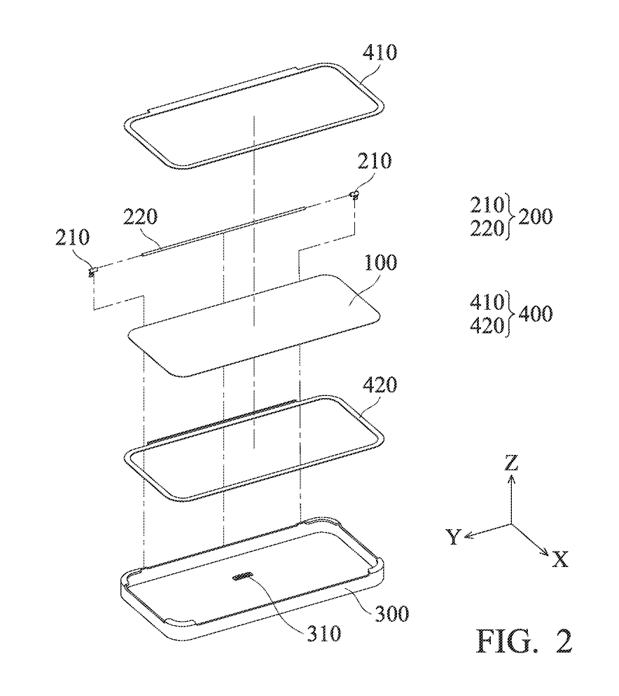

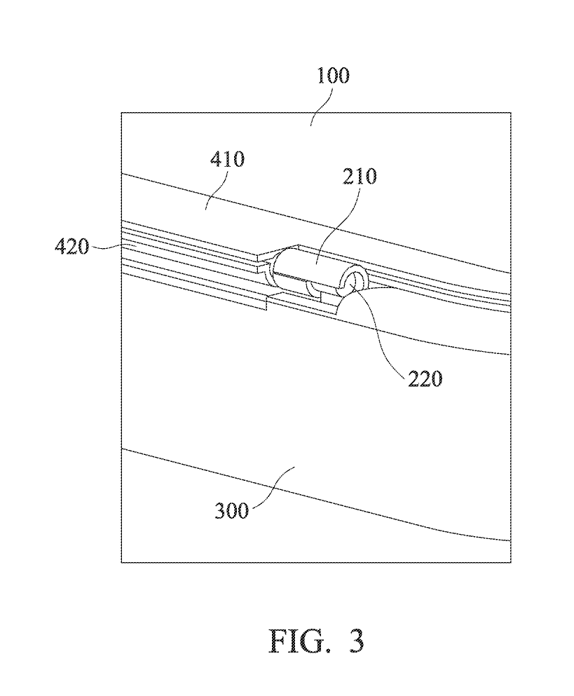

Referring to FIGS. 1-3, a display equipment in an embodiment of the invention primarily comprises a flat optical component 100, a pivot unit 200, an accommodating member 300, and a gripper 400. The gripper 400 comprises a first clamping member 410 and a second clamping member 420, and the optical component 100 is fixed therebetween. The pivot unit 200 comprises two pivot members 210 and a hinge 220, wherein the pivot members 210 are fixed on the accommodating member 300, and the hinge 220 is pivotally and rotatably connected to the pivot members 210. Furthermore, the hinge 220 is clamped between the first clamping member 410 and the second clamping member 420, such that the optical component 100 can be fixed on the hinge 220 (as shown in FIG. 3). In other words, the optical component 100 and the gripper 400 are pivotally connected to the accommodating member 300 by the pivot unit 200, and the optical component 100 can rotate around a rotation axis A relative to the accommodating member 300 (FIG. 1).

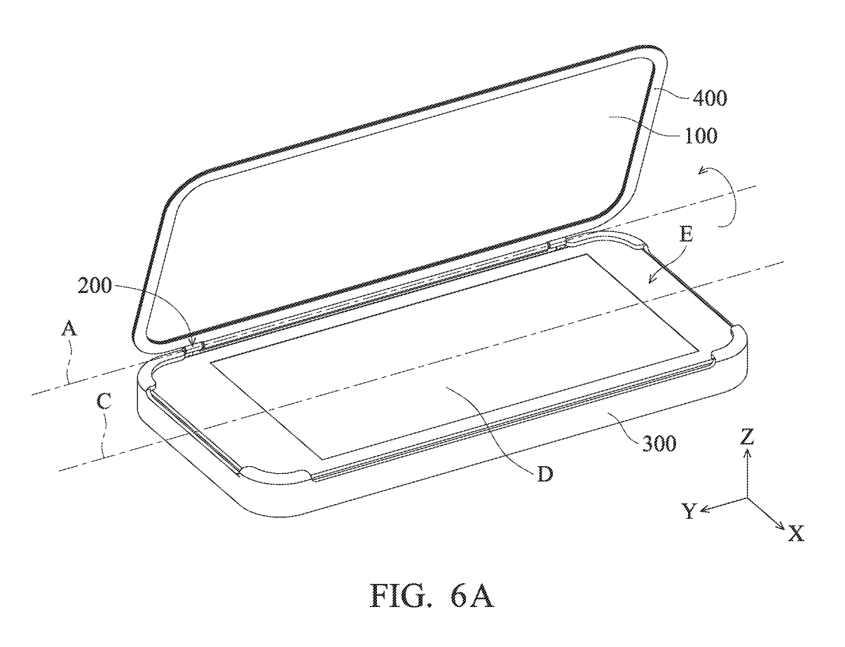

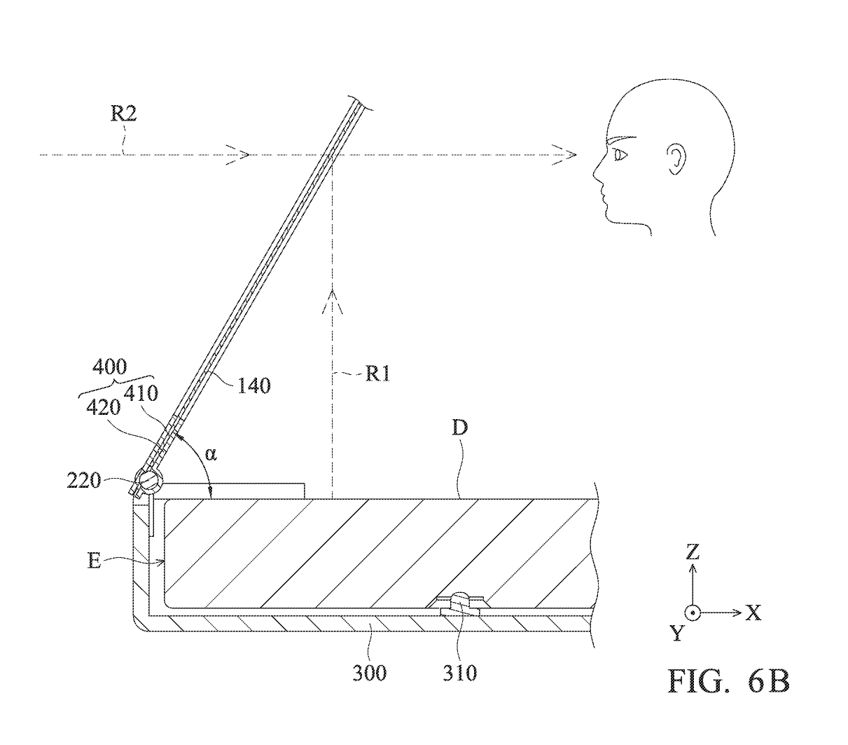

It should be noted that, in this embodiment, the accommodating member 300 comprises plastic or other flexible materials. Therefore, an electronic device E (for example, a smartphone or a tablet computer) can be easily put in the accommodating member 300 (as shown in FIG. 6A). The accommodating member 300 has an electrical connector 310 (FIG. 1) for electrically connecting the electronic device E.

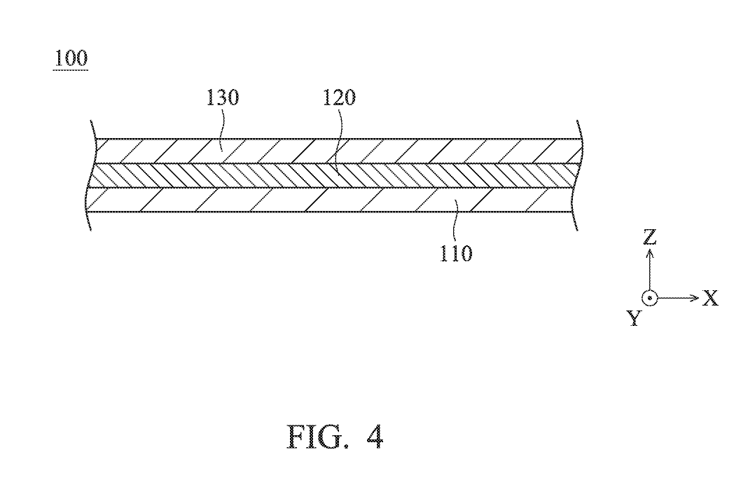

Referring to FIG. 4, in this embodiment, the optical component 100 primarily has three layers, comprising a transparent insulating member 110, a semitransparent reflective member 120, and a transparent protecting member 130. The semitransparent reflective member 120 is disposed between the transparent insulating member 110 and the transparent protecting member 130. These three layers are attached to each other and have no gap therebetween. The transparent insulating member 110 comprises plastic, the semitransparent reflective member 120 comprises a polyester film, and the transparent protecting member 130 comprises acrylic.

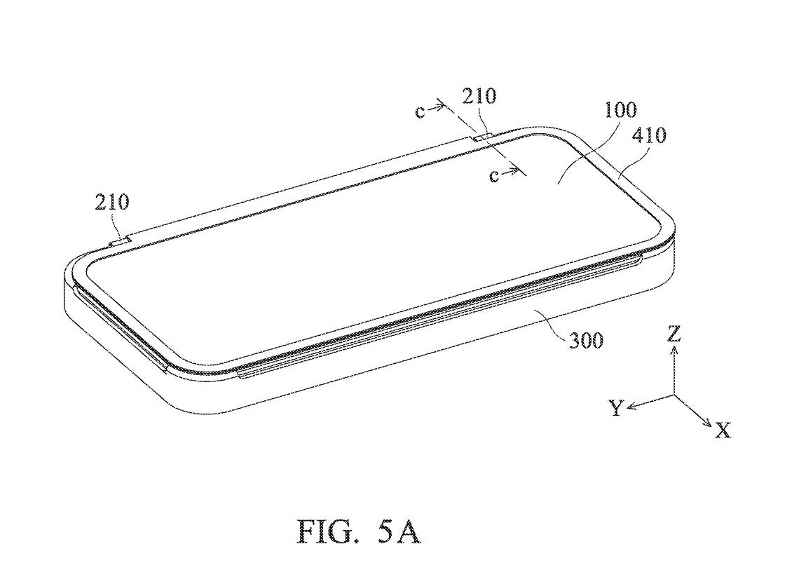

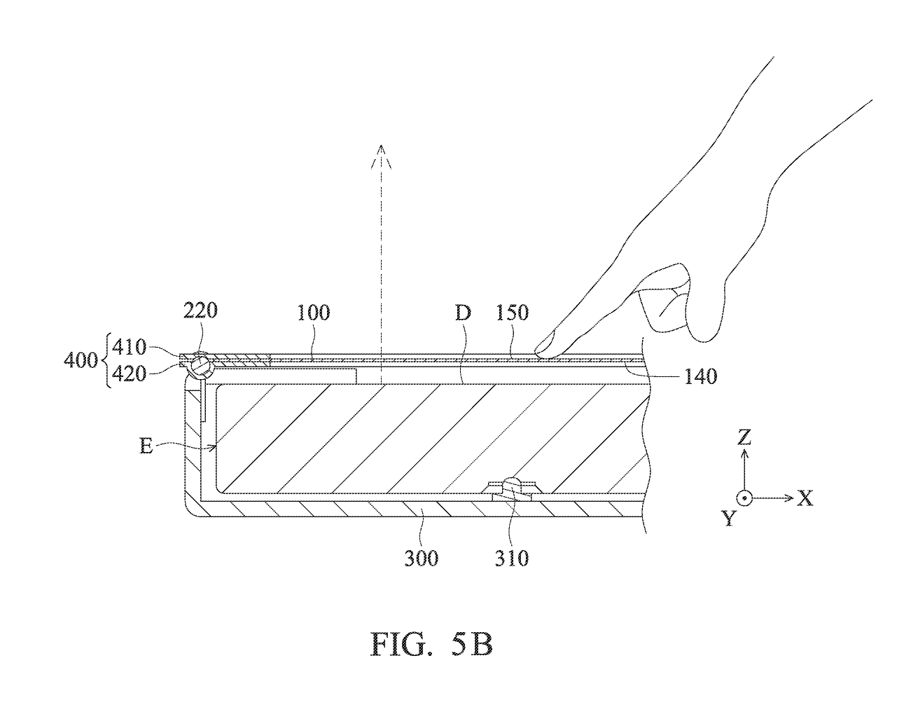

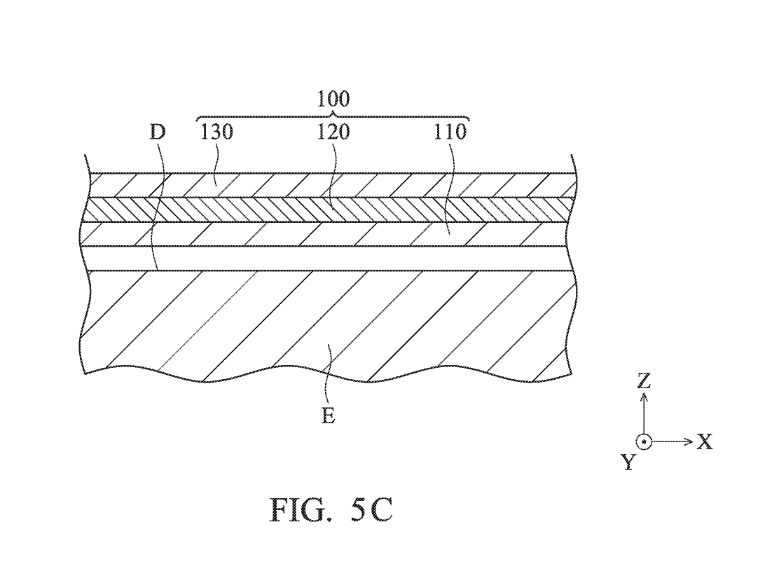

As shown in FIGS. 5A and 5B, when the electronic device E is disposed in the accommodating member 300, and the optical component 100 is in a first position relative to the electronic device E, a surface 140 of the optical component 100 is parallel and faces a display surface D of the electronic device E. The light emitted from the display surface D can pass through the transparent insulating member 110, the semitransparent reflective member 120, and transparent protecting member 130 of the optical component 100 sequentially (the arrow in FIG. 5B). That is, the user can watch the image on the display surface D without opening the optical component 100. Moreover, since the thickness of the optical component 100 is small (between 0.1 mm-0.2 mm, such as 0.14 mm), the user can control the electronic device E by touching the surface 150 opposite to the surface 140 when the touch control function of the electronic device E is generated by an optical sensing method.

Specifically, as shown in FIG. 5C, when the optical component 100 is in the first position, the transparent insulating member 110 is disposed between the semitransparent reflective member 120 and the electronic device E. Therefore, the sensing is not generated even if the optical component 100 contacts the display surface D when the electronic device E comprises a capacitive sensing touch panel. Furthermore, when the optical component 100 is in the first position, the semitransparent reflective member 120 is disposed between the transparent protecting member 130 and the electronic device E. The transparent protecting member 130 has a certain rigidity, such that the damage of the semitransparent reflective member 120 and the display surface D from being compressed or scraped can be prevented. In some embodiments, the transparent insulating member 110 and the transparent protecting member 130 can be removed as required to reduce the thickness of the optical component 100.

Referring to FIGS. 6A and 6B, when the optical component 100 and the gripper 400 rotate from the first position around the rotation axis A to a second position through the pivot unit 200, the optical component 100 can be fixed in the second position by the friction between the hinge 220 and the pivot member 210, and an inclined angle a is formed between the surface 140 and the display surface D (as shown in FIG. 6B). The light R1 emitted from the display surface D can be reflected by the optical component 100 to the user, such that the user can directly watch the surface 140 and remember the image on the display surface D. Some background light R2 is not shielded by the optical component 100, and therefore the sight on the back of the optical component 100 can be seen by the user.

It should be noted that, in this embodiment, the display equipment can detect the rotating angle of the hinge 220 to remember the angle between the surface 140 and the display surface D. When the inclined angle a is formed between the surface 140 and the display surface D, the display equipment can transfer a signal through the electrical connector 310 to the electronic device E. When the electronic device E receives the aforementioned signal, the image on the display surface D can be mirrored relative to a central axis C, wherein the central axis is parallel to the rotation axis A. Thus, the image on the surface 140 is upright. The inclined angle a is about 30°-80°, for example.

In this embodiment, the dimensions of the optical component 100 exceed or are equal to those of the display surface D, such that the image on the display surface D can be entirely projected to the optical component 100. Furthermore, in some embodiments, the pivot unit 200 can be disposed on the electronic device E. The optical component 100 can be pivotally connected to the electronic device E through the pivot unit 200 directly, and the accommodating member 300 can be omitted.

In summary, the display equipment and the display method are provided. When the optical component of the display equipment covers the display surface of the electronic device, and the optical component is parallel to the display surface, the user can directly watch and control the electronic device without opening the optical component. When the optical component rotates to the inclined angle relative to the electronic device, the user can watch the image on the optical component, which is reflected from the display surface. Furthermore, the sight on the back of the display equipment can be seen by the user, such that safety can be improved.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A display equipment connected to an electronic device, comprising:
a flat optical component, comprising a semitransparent reflective member for reflecting the light emitted from a display surface of the electronic device; and
a pivot unit, pivotally connected to the optical component and the electronic device, wherein when the optical component is in a first position and substantially parallel to the display surface, the light emitted from the display surface passes through the optical component, wherein when the optical component rotates from the first position to a second position relative to the electronic device with an inclined angle formed between the optical component and the display surface, the light emitted from the display surface is reflected by the semitransparent reflective member to a user.

2. The display equipment as claimed in claim 1, wherein the optical component further comprises a transparent protecting member connected to the semitransparent reflective member, wherein when the optical component is in the first position, the semitransparent reflective member is disposed between the transparent protecting member and the electronic device.

3. The display equipment as claimed in claim 1, wherein the optical component further comprises a transparent insulating member connected to the semitransparent reflective member, wherein when the optical component is in the first position, the transparent protecting member is disposed between the semitransparent reflective member and the electronic device.

4. The display equipment as claimed in claim 1, wherein the display equipment further comprises an accommodating member for accommodating the electronic device, and the pivot unit is pivotally connected to the accommodating member and the optical component.

5. The display equipment as claimed in claim 4, wherein the accommodating member comprises an electrical connector for electrically connecting the electronic device.

6. The display equipment as claimed in claim 1, wherein the thickness of the optical component is 0.1 mm-0.2 mm.

7. The display equipment as claimed in claim 1, wherein the dimensions of the optical component exceed or are equal to those of the display surface.

8. A display method, comprising:
providing an optical component, wherein the optical component is rotatable around a rotation axis relative to an electronic device and comprises a semitransparent reflective member;
rotating the optical component and forming an inclined angle between the optical component and a display surface of the electronic device; and
mirroring an image on the display surface relative to a central axis of the display surface when the inclined angle is formed between the optical component and the display surface, wherein the mirrored image is reflected to a user by the semitransparent reflective member, and the central axis is parallel to the rotation axis.

9. The display method as claimed in claim 8, wherein the inclined angle is 30°-80°.

10. The display method as claimed in claim 8, wherein the electronic device is a smartphone or a tablet computer.
